(19) United States
(12) Patent Application Publication
(10) Pub. No.: US 2009/0207006 A1
(43) Pub. Date: Aug. 20, 2009

(54) Method for Functionally Testing an Ultrasonic Sensor

(76) Inventors: Karl-Heinz Richter, Weil Der Stadt (DE); Peter Preissler, Dorndorf (DE)

Correspondence Address: KENYON & KENYON LLP, ONE BROADWAY, NEW YORK, NY, 10004, US

(21) Appl. No.: 11/886,624

(22) PCT Filed: Mar. 14, 2006
(86) PCT No.: PCT/EP2006/060681

§ 371 Date: Jan. 27, 2009

(30) Foreign Application Priority Data
Mar. 24, 2005 (DE) 10 2005 013 589.7

(51) Int. Cl. G01S 15/93; G01S 7/52

(52) U.S. Cl. 340/435; 367/13

(57) ABSTRACT

A method for functionally testing an ultrasonic sensor in which at least one additional ultrasonic sensor transmits an ultrasound signal, and a functioning of the first sensor is ascertained when the amplitude of the signal transmitted by the first sensor without being reflected off of an external obstacle exceeds a predefined, variable limit value.

### BACKGROUND INFORMATION

A device for monitoring vehicle back-up safety systems is described in European Patent Application No. EP 312 845. At least two transmitter/receiver pairs, which each have an assigned electroacoustic transducer and are operated using the sound reflection method, are mounted at the rear end of the vehicle. An acoustic shunt is provided between two adjacent transducers, so that the signal received at any one time from an adjacent transmitter is evaluated as a function monitoring signal.

From German Patent Application No. DE 199 24 755, a distance-sensing device is known, which is used to analyze crosstalk signals between two sensors in order to monitor functioning. In this connection, a received signal is compared to a fixed, predefined threshold.

### SUMMARY OF THE INVENTION

Against this background, the method according to the present invention for functionally testing an ultrasonic sensor has the advantage that a signal emitted by another sensor for functional testing purposes, is compared to a variable limit value for the amplitude signal. This makes it possible, in particular, to detect a gradual fading of the sensor, caused, for example, by icing, dirt accumulation, aging or other interference effects. Moreover, for a more effective functional testing, it is possible to adapt the sensor as precisely as possible to its installation position, to obtain reliable information about the sensor functioning. As a result, more reliable information is obtained as to whether the sensor is functioning perfectly.

It is particularly advantageous to provide an evaluation time window within which the received signal must exceed the limit value. In this context, the evaluation window may be advantageously associated with a measurement window in such a way that the measurement window directly follows the evaluation window for the purpose of functional testing. Thus, there may be a direct correlation between the subsequent measurement and the information regarding whether the sensor is functioning reliably or not. In particular, only stochastically occurring errors or sudden failures during the measurement operation may be detected in this manner.

In addition, it is beneficial to vary the limit value over the duration of the time evaluation window. In particular, by varying the limit value during the evaluation window, it is possible to provide different limit values for signals that are emitted by various other ultrasonic sensors. It is then expected that a signal which is transmitted by a more distant sensor and which has a longer propagation time than a signal transmitted by a more proximate sensor, will also have a lower amplitude. By varying the limit value during the evaluation window, a signal reception may be detected by both sensors, thereby enhancing the reliability of the functional test. In some instances, this also makes it possible to infer a functioning of other ultrasonic sensors as transmitters.

It is also advantageous for the sensors to be provided on one common carrier structure through which the sound is transmitted from one sensor to another. In this case, the limit value is advantageously adapted to the mounting location, the distance between the two sensors, and the installation conditions prevailing in the carrier structure. The adaptation is advantageously carried out during sensor installation. However, a later recalibration is also possible. Particularly with regard to the retrofitting of sensors, a threshold value control may be adapted to the actual conditions in a calibration process.

In addition, the limit value is advantageously varied as a function of the vehicle's measured values or of measured values relating to the vehicle's surrounding field. In this connection, the vehicle velocity or the ambient temperature may, in particular, be properly taken into account. In this connection, it is especially advantageous for the limit value to be variably selected as a function of the mounting location on the vehicle.

Moreover, in the case of a malfunction of the ultrasonic sensor, a warning is advantageously output to a driver. This alerts the driver of the potential risk that obstacles are no longer able to be seen by the ultrasonic sensor. Thus, he can no longer depend on a measured value indication provided by a distance measuring device. In some instances, he may also be prompted by the warning to clean or deice the ultrasonic sensors.

To ensure that individual measurement errors do not prematurely cause such a warning to be output, it is preferable for a warning to be output when no functioning of the sensor is ascertained following a multiplicity of successive measurements, for example. Since the measurements are repeated relatively quickly, there is still no endangerment to a user associated herewith, unnecessary warnings being avoided, however.

### BRIEF DESCRIPTION OF THE DRAWINGS

FIG. 1 shows a schematic illustration of a motor vehicle having a distance measuring device which has ultrasonic sensors and is operated in accordance with the present invention.

FIG. 2 shows two ultrasonic sensors of a distance measuring device according to the present invention.

FIG. 3 shows a characteristic curve of the amplitude of a received ultrasonic signal when implementing the method according to the present invention.

### DETAILED DESCRIPTION

The present invention may be employed for any distance measuring devices having ultrasonic sensors. Its use is particularly advantageous for a distance measuring device in a motor vehicle, since a driver relies upon the warnings of a distance measuring device, warning him prior to a collision with obstacles in the vehicle's surrounding field. The certain detection of a loss or a limitation of the detection capability ensures that, in the event of a declining sensor performance, a driver receives feedback to this effect, allowing him to either restore the functional performance of the distance measuring device or to no longer rely on a warning indication therefrom, at least for the duration of the disturbance.

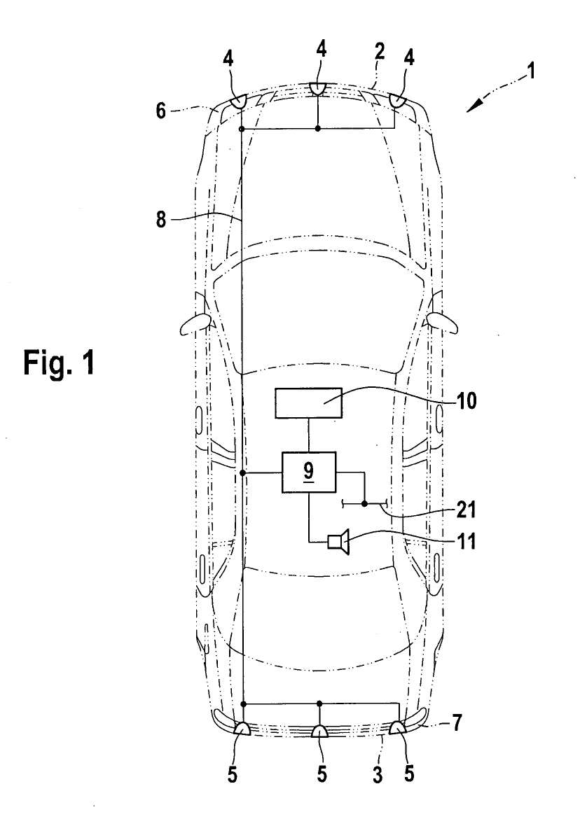

A motor vehicle 1 is schematically shown in FIG. 1. Ultrasonic sensors 4, 5 are mounted at a front end 2 and a rear end 3, respectively, of motor vehicle 1. In this case, ultrasonic sensors 4, 5 are preferably installed in a front bumper 6, respectively in a rear bumper 7 of the vehicle. Generally, ultrasonic sensors 4, 5 have a vibratory membrane which at least partially penetrates bumper 7, so that ultrasound signals are emitted into the vehicle's surrounding field. The ultrasound signals are reflected off of an obstacle in the vehicle's surrounding field and received again by ultrasonic sensors 4, 5. To this end, ultrasonic sensors 4, 5 are preferably designed as ultrasonic transmitters and as ultrasonic receivers. Ultrasonic sensors 4, 5 are linked via a data bus 8 to an evaluation unit 9 in the vehicle.

In this context, ultrasonic sensors 4, 5 have an evaluation unit (not shown in detail in FIG. 1), which is used to analyze the received ultrasound signal. In this context, an ultrasound transmission impulse is composed of a multiplicity of individual signals which make up an ultrasound pulse, so that one signal envelope curve may describe the emitted ultrasound signal. The received signal also has an envelope curve which encompasses the maximum values of the individual ultrasound vibrations. In one specific embodiment, the evaluation electronics of ultrasonic sensors 4, 5 determines whether a signal has been received or not. A determination is made, for example, by comparing an amplitude of a signal envelope curve with a stored limit value. If the limit value is exceeded, than this exceedance is transmitted digitally, for example, to evaluation unit 9. In this context, direct echoes may be evaluated, in which case ultrasonic sensors 4, 5 receive the signals again that they themselves had transmitted. In another specific embodiment, cross-echoes may also be evaluated, in which case a signal emitted by another ultrasonic sensor is received again after being reflected off of an obstacle. Evaluation unit 9 analyzes the signals transmitted by individual ultrasonic sensors 4, 5. It determines the propagation time from the time difference between emission and reception of the signal and, on the basis thereof, including the velocity of sound in the consideration, determines the distance to the obstacle. If the result falls short of a minimum distance to an obstacle, evaluation unit 9 outputs a warning to this effect. To this end, evaluation unit 9 is linked, for example, to a display unit 10 and/or to an acoustic output unit 11, preferably to a loudspeaker.

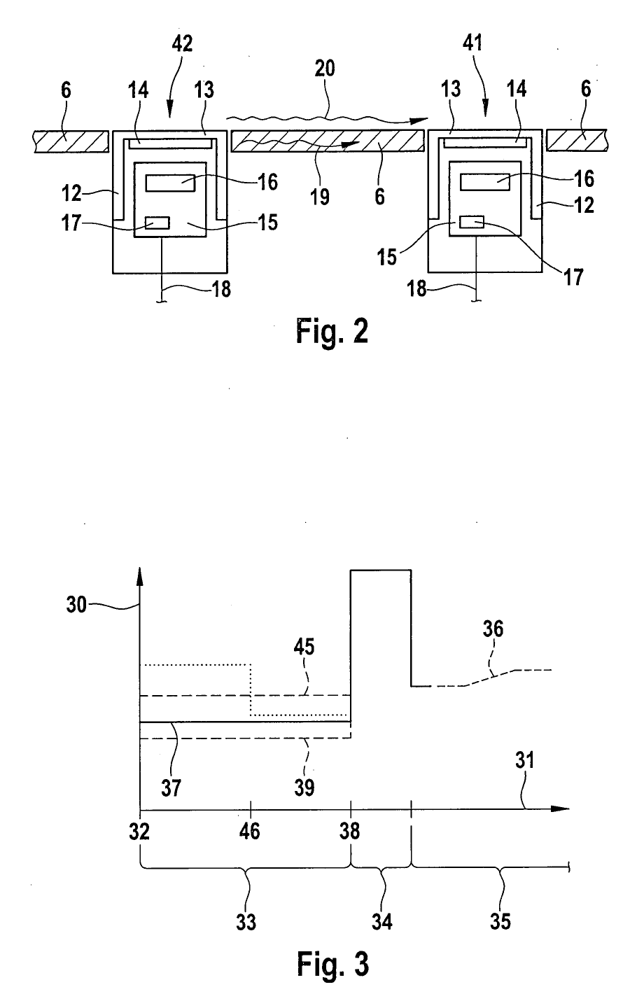

A first ultrasonic sensor 41 and a second ultrasonic sensor 42 are shown in detail in FIG. 2. The two ultrasonic sensors 41, 42 are identical in design in the exemplary embodiment shown here, however, they may exhibit structural differences in order to facilitate assembly or adaptation to a mounting location. Both sensors have a sensor casing 12. Sensor casing 12 has a membrane 13 which is outwardly oriented relative to the vehicle and is thus used for monitoring the vehicle's surrounding field. In the example shown here, sensors 41, 42 are installed, together with the sensor casing, in front bumper 6. In this connection, sensor casing 12, together with membrane 13, projects through orifices provided for that purpose in bumper 6. Membrane 13 is excited into vibrations by a piezotransducer 14, causing it to emit an ultrasound signal. To this end, piezotransducer 14 is controlled by an electronic unit 15. Each electronic unit 15 has an arithmetic-logic unit 16 and a memory 17. Arithmetic-logic unit 16 is linked via a connection 18 to data bus 8. In a transmitter operating mode, piezotransducer 14 is controlled by electronic unit 15 in such a way that membrane 13 emits an ultrasound signal. In a receiving operating mode, an ultrasound signal may excite membrane 13, so that the excitation is transmitted to piezotransducer 14. This excitation is detected by electronic unit 15 and processed by arithmetic-logic unit 16. A reception of an ultrasound signal is ascertained as a function of the detected signals.

When a measurement operation is performed, the transmitted signals are reflected off of an external obstacle (not shown in FIG. 2) outside of the vehicle and received again by sensors 41, 42. If a signal is transmitted by second ultrasonic sensor 42, then not only is the first ultrasonic sensor able to receive a signal reflected off of an obstacle, but sound signals also reach first ultrasonic sensor 41 via a direct path. Thus, the sound signals generated by the second ultrasonic sensor may also be coupled into the carrier structure of ultrasonic sensors 41, 42 in bumper 6, for example. This sound is then transmitted via bumper 6 to first ultrasonic sensor 41. It is represented in FIG. 2 by a first arrow 19. In addition, sound from second ultrasonic sensor 42 is also carried directly through the air to reach first sensor 41. This sound is represented by a second arrow 20 in FIG. 2. If, at this point, first sensor 41 is operated as a receiver and second sensor 42 isochronously as a transmitter, a signal transmitted by second sensor 42 arrives at first sensor 41 before the signal emitted by second sensor 42 is reflected off of an obstacle, since the signal path from second sensor 42 to any given obstacle and continuing to first sensor 41 is always further than a distance of a direct sound conduction between the second and the first sensor.

However, if first sensor 41 is soiled, for example, by snow, ice, slush, or the like, or if it has been damaged, either membrane 13 of first ultrasonic sensor 41 is not able to be excited into vibration, or, in the case that an excitation has taken place, it is potentially not detected by electronic unit 15 of first ultrasonic sensor 41. In such circumstances, a signal reflected off of an obstacle is not able to be sensed or at least not reliably sensed, so that a warning could potentially not be output before an obstacle is reached. However, an ultrasound signal transmitted by second ultrasonic sensor 42 to an obstacle is also not detected by the first ultrasonic sensor.

To ascertain a functioning of first ultrasonic sensor 41, evaluation unit 9 transmits both a signal to the second ultrasonic sensor prompting it to transmit a signal, as well as a command for receiving a signal to first ultrasonic sensor 41. At this point, first ultrasonic sensor 41 listens for signals transmitted by second ultrasonic sensor 42 directly via paths 19, 20, i.e., without being reflected off of an external obstacle. The received ultrasound signal is converted by piezotransducer 14 into a voltage signal. The voltage signal describes a maximum amplitude of the envelope curve of a received ultrasound signal of one resonant frequency of the membrane within a predefined time window, for example. A limit value for the voltage signal is stored in memory 17 for evaluation purposes. If the detected voltage signal is able to exceed a limit value stored in memory 17, then a functioning of the sensor is ascertained. If the limit value stored in memory 17 is not able to be exceeded, then this is indicative of a possible malfunction of the ultrasonic sensor. The limit value stored in memory 17 is either adjustable in memory 17 itself, or by arithmetic-logic unit 16 subsequently to its reading out of the same. The adjustments are clarified with reference to the diagram shown in FIG. 3.

In FIG. 3, a detection threshold is plotted as voltage on Y-axis 30 over time on X-axis 31. Beginning from a start of measurement at a first instant 32, first ultrasonic sensor 41 is switched into a receiving mode. In this context, first instant 32 is identical to the transmission instant of the ultrasound signal from second sensor 42, or is immediately subsequent thereto. In a first measuring interval corresponding to evaluation window 33, the previously described functional test is performed on the ultrasonic sensor. This is optionally followed by a dead time 34 during which a detection threshold of first sensor 41 is selected to be so high that no received signal is able to be detected, since all possible received signals reside below the detection threshold provided in dead time 34. Directly following evaluation window 33 or dead time 34 is actual measurement window 35, during which first sensor 41 listens for the signal from second sensor 42 that is reflected off of an external obstacle, in order to enable a distance to the external obstacle to be determined from the propagation time between the transmission instant and the reception instant. Indicated by a dashed line for this instant is a threshold value curve 36, which, for example, is adapted to the sensor's distance from the surface, to the sensor's mounting location in the vehicle, to the air temperature, or to other conditions in the vehicle. The characteristic of measuring curve 36 during measurement window 35 is preferably independent of a limit value for a functional test of the sensor for receiving the sound signal directly transmitted from second sensor 42 during evaluation window 33. In a first exemplary embodiment, FIG. 3 shows a constant limit value 37 for the characteristic of a threshold value curve during evaluation window 33. During evaluation window 33, each exceedance of the indicated limit value by the amplitude of a received ultrasound signal prompts the decision in arithmetic-logic unit that first sensor 41 is functioning. If the limit value is not exceeded, then a malfunction is ascertained.

In this context, the level of limit value 37 is variable. In a first specific embodiment, the level of limit value may be specified in memory 17 during installation of the sensor or during manufacture of a suitable distance measuring device. In such a case, the level of the limit value is dependent in particular on the sensor's mounting location and, in connection therewith, on the distance or angle of the sensors relative to each other. If the distance between the sensors is rather substantial, then the limit value is selected to be smaller. Conversely, when sensors are located in closer mutual proximity, the limit value may be increased, since the smaller distance allows the signal to be transmitted with a larger amplitude between the two sensors. Besides the level of the limit value, the duration of the evaluation window between first instant 32 and an end 38 of the evaluation window may be adjusted during the installation. In this case, consideration should generally be given to the sound propagation time through potentially different materials, thus, for example, through air or through bumper 7. Generally, distances of 15 to 80 cm between two ultrasonic sensors are to be considered.

The level of the limit value may be influenced by the material used and the installed shape of a mounting bracket (not shown in FIG. 2) for a sonic sensor. Thus, for example, if there is an efficient coupling of sound between the ultrasonic sensor and the bumper, the limit value may be set to be higher than in the case of a poor coupling of sound. If the ultrasonic sensors point toward each other, supported, as the case may be, by an appropriate funnel-type structure for focusing the ultrasound signal, then the limit value may likewise be increased. On the other hand, if the ultrasonic sensors point away from each other, particularly in the case of a convexly shaped bumper, then the limit value is to be lowered. In this case, contrary effects may also occur, such as in the case of a bumper having good sound conduction properties, but a convex placement of the sensors. In case of doubt, it is necessary to empirically check the level of the limit value, particularly in the case that a user of a vehicle undertakes a retrofitting of ultrasonic sensors himself.

However, besides statically defining the limit value for a particular sensor during an installation on the vehicle or for a later calibration, dynamic values may also be considered by arithmetic-logic unit 16. To this end, evaluation unit 9 is preferably linked to a vehicle data bus 21, via which an outside temperature or a vehicle's velocity may be evaluated, for example. At higher velocities, in particular, the air flow may cause interference in the sound transmission between the sensors. This interference may be more pronounced at the front end of the vehicle than at the rear end. If a predefined vehicle velocity is exceeded, then this requires lowering of limit value 37 by arithmetic-logic unit 16 in response to increasing vehicle velocity. In some instances, different limit values may be provided for the front end and the rear end of the vehicle. Another specific embodiment also provides the option of suspending the test in the case of excessively high velocity or extreme fluctuations in the outside temperature.

In a first specific embodiment, the limit value for entire evaluation window 33 may be constantly varied, so that it is lowered to a constant value 39 or increased to constant value 45, for example. However, in another specific embodiment, it is also possible to subdivide the evaluation window. In this connection, the limit value up to a second instant 46 is higher than between second instant 46 and end 38 of evaluation window 33. This makes it possible to take into account that, during the first part of the evaluation window, a sound signal from another, more proximate ultrasonic sensor is detected, while, in the second part of evaluation window 33, an ultrasound signal is received from another, more distant ultrasonic sensor.

If an exceedance of the limit value is not detected during the evaluation window, then a first specific embodiment provides for immediately outputting a warning alerting a driver of motor vehicle 1 that at least one ultrasonic sensor is not functioning. However, in another specific embodiment, a counter is first incremented, and is then reset when a signal is received again. A warning is not output until a plurality of successive measurements, thus, for example 10 to 25 measurements, preferably 20 measurements, reveal that no signal from another sensor is detected during evaluation window 33. This prevents individual spurious measurements from causing a warning to be output.

In place of a constant limit value, the limit value during evaluation window 33 may also be represented by any shaped curve.

The sensors in this kind of operation are preferably switched (operated) in a way that permits mutual testing of each other. To this end, a first sensor is initially operated as a transmitter and a second sensor as a receiver. In a subsequent measuring step, the test is performed the other way around, the transmitter and receiver being reversed. If a plurality of sensors are present, they may also test each other in a reciprocal operation. An additional test may be performed as a self-test in which the ultrasonic sensors are operated in a direct-echo mode, and in which they again receive their own transmitted signal which, as the case may be, is reflected off of an obstacle or is used to at least excite membrane 13.

A change in the limit value is stored in memory 17. In a first specific embodiment, an adapted limit value is written into memory 17 during manufacture of the sensor. In another specific embodiment, however, the limit value may also be written by evaluation unit 9 into memory 17. This procedure may be carried out in connection with an automatic determination of the limit value. In addition, the limit value, which is stored, for example, in the form of a voltage value, may, however, also be predefined by a user and be communicated via evaluation unit 9 to memory 17. In the case the limit value is adapted during motor vehicle travel, a new limit value may be transmitted by evaluation unit 9 to memory 17. However, a correction signal may also be transmitted to the particular sensor, so that, during the measurement, arithmetic-logic unit 16 corrects the limit value stored in memory 17 on the basis of the correction signal.

1-10. (canceled)

11. A method for functionally testing a first ultrasonic sensor of a distance measuring device having at least two ultrasonic sensors, comprising:
conducting a signal transmitted by a second ultrasonic sensor of the distance measuring device to the first ultrasonic sensor without being reflected off of an external obstacle;
when the first sensor receives the signal transmitted by the second sensor, ascertaining a functioning of the first sensor; and
ascertaining a reception when an amplitude of the signal from the second sensor received by the first sensor exceeds a variable limit value.

12. The method according to claim 11, wherein, in the case of the first sensor, an evaluation time window is provided which directly follows a transmission operation of the second sensor and within which the limit value must be exceeded by a received signal in order to ascertain a functioning of the first sensor.

13. The method according to claim 12, wherein the limit value is varied over a duration of the evaluation time window.

14. The method according to claim 11, wherein the first and second ultrasonic sensors are mounted on a carrier structure, and further comprising transmitting a sound signal via the carrier structure from the second to the first ultrasonic sensor.

15. The method according to claim 14, wherein the limit value is specified when the ultrasonic sensors are installed in the carrier structure or when the carrier structure is installed.

16. The method according to claim 11, wherein the limit value is varied as a function of a vehicle's measured values or of measured values relating to a vehicle's surrounding field.

17. The method according to claim 16, wherein the limit value is varied as a function of a mounting location of the sensors.

18. The method according to claim 11, further comprising outputting a warning when no functioning of the first sensor is ascertained.

19. The method according to claim 18, wherein a warning is not output until it is ascertained following a multiplicity of successive measurements that there is no functioning of the first sensor.

20. A distance measuring device comprising:
at least two ultrasonic sensors which are installed in such a way that an ultrasound signal transmitted by a second ultrasonic sensor is able to be received by a first ultrasonic sensor without being reflected off of an external obstacle, a variable memory for storing an amplitude value being included in the first sensor, the signal received from the second sensor without being reflected off of an external obstacle being compared with the stored amplitude value in such a way that only in the case of an exceedance of the stored amplitude value is a functioning of the first ultrasonic sensor ascertained.
